(19) United States
(12) Patent Application Publication
(10) Pub. No.: US 2009/0100742 A1
(43) Pub. Date: Apr. 23, 2009

(54) Apparatus for and method of maximizing attraction of mosquitoes

(76) Inventors: James E. Cilek, Panama City, FL (US); Charles F. Hallmon, Lynn Haven, FL (US)

Correspondence Address: Norris, Braden, Melton & Gregersen, PLLC, Suite 305, 1901 Pennsylvania Avenue, Washington, DC, 20006, US

(21) Appl. No.: 11/976,168

(22) Filed: Oct. 22, 2007

(51) Int. Cl. A01M 1/02

(52) U.S. Cl. 43/107

(57) ABSTRACT

In a method of attracting mosquitoes using a mixture of carbon dioxide and a mosquito attractant, the improvement of maximizing attraction by preventing or substantially minimizing absorption of moisture into the attractant that would distort the weight of the attractant left after effusion of attractant in a plume, comprising:
a) regulating flow of CO₂ through an inlet containing a desiccant into a confined chamber;
b) allowing CO₂ from step a) to admix with an attractant vapor emitted from a wick extending through an opening in an enclosed vial containing a liquid attractant in the confined chamber;
c) emitting an admixture of desiccated CO₂ and attractant as a plume through an outlet of the confined chamber to lure mosquitoes for a predetermined time; and
d) weighing the amount of liquid attractant left in the enclosed vial to ascertain the amount of vaporous attractant emitted in the plume to ascertain the number of mosquitoes attracted per amount of attractant.

### FIELD OF THE INVENTION

The invention relates to apparatus for and methods of maximizing attraction of mosquitoes that are inclined to bite, so that these mosquitoes are lured to a trap to prevent vector-borne disease transmission.

### BACKGROUND OF THE INVENTION

It is known by entomologists that mosquitoes are attracted by light, blue color, heat, and carbon dioxide. Given this knowledge, most devices for trapping incorporate a light source that gives off an amount of heat and some form of carbon dioxide alone (to mimic a mammal) or with another substance to lure the mosquitoes to a trap or “killing zone”.

For example, U.S. Pat. No. 6,655,078 disclose a mosquito and biting insect attracting apparatus that includes a heat element (a thermal lure), a source of carbon dioxide (CO₂), and a source of a chemical biting insect attractant, such as octenol. Heat for the thermal lure and the source of CO₂ are provided by a propane flame. The apparatus includes a structure that surrounds a propane burner and that is heated by the burner to a temperature that is similar to that of a small animal. The structure includes a series of baffles and conduction elements that permit the structure to have a constant heat signature, which is desirable for attracting mosquitoes. A mechanism may be provided for trapping or killing the attracted mosquitoes, such as an adhesive substance or an electronic grid.

NO₂ is used as an attractant enhancer in conjunction with CO₂ in U.S. Pat. Appl. No. 2006042155. NO₂ may also be used to enhance other attractants, alone or in combination, such as octenol, thermal or light lures, or any other insect attractant known in the art.

U.S. Pat. No. 6,286,249 disclose a device for attracting and capturing or disabling insects, that includes a fan mechanism structured and arranged to provide an outflow of air out of the device to atmosphere, and to draw an inflow directed counter the outflow from atmosphere into the device, the outflow being substantially within the inflow outside of the device. The flow mechanism is also structured and arranged to provide an insect attractant in the outflow. The device can include a mounting structure adapted to position the device with the outflow directed in a substantially downward direction. The outflow attracts insects to the vicinity of the device, and the inflow urges the insects to enter the device. An insect disabling structure is arranged with the flow mechanism to capture or disable insects being urged into the device by the inflow.

An apparatus for attracting and destroying insects that includes a housing, a canister secured to the housing and containing carbon dioxide, and a discharge device for discharging the carbon dioxide from the canister is disclosed in U.S. Pat. No. 5,799,436. The apparatus further includes a source of octenol provided in the housing, and a device for introducing and mixing the octenol with the carbon dioxide within the housing. The mixture of carbon dioxide and octenol is released from the housing for attracting insects. A heat source is also provided for further attracting insects, and an electric grid secured to and surrounding the housing destroys the insects upon their contacting the grid.

There is a need in the art of attracting mosquitoes to ascertain the most efficient and expeditious manner of attracting the different species of biting female mosquitoes, as these biting mosquitoes need blood to provide the protein for egg production, and therefore have the propensity for spreading diseases with their bites.

### SUMMARY OF THE INVENTION

In accordance with the invention, there is a provided a confined chamber release apparatus and method of using the same to maximize attraction of mosquitoes, towards the end of preventing transmission of diseases.

Another aspect of the invention is to ascertain the most prodigious combination of attractants per unit of flow rate to attract the greatest number of mosquitoes using said chamber, towards the end of preventing transmission of diseases.

A further aspect of the invention is to minimize the tendency of hygroscopic attractants to absorb moisture from humid environments and therefore prevent distortion of measurements when determining the level of mosquitoes drawn by the hydroscopic attractant upon weighing the attractant after initially deploying same as the lure.

### BRIEF DESCRIPTION OF THE DRAWINGS

To enhance better comprehension of the invention, described below are embodiments of the invention with reference to the accompanying drawings, of which:

FIG. 1 shows the exterior of the confined release chamber showing an entrance port and an exit port, and wherein a threaded cap or top with an eye screw therein is depicted.

FIG. 2 is an exploded view of the interior of the confined release chamber principally showing a vial slip plate in which aromatic attractants (preferably liquid) are inserted to enable flowing carbon dioxide to carry the attractant in a mixture of carbon dioxide and attractant out of the exit port to lure mosquitoes.

FIG. 3 is a top view of the vile slip plate showing openings for inserting vials of the attractant that are released in a mixture with flowing carbon dioxide.

FIG. 4 is an expanded view of the carbon dioxide inlet aperture to the confined release chamber, wherein a desiccant is used in the inlet to absorb any moisture that may enter while metering in carbon dioxide.

FIG. 5 is a side view of a capped vial with an aperture therein through which an attractant wetted wick extends.

### DETAILED DESCRIPTION WITH REFERENCE TO DRAWINGS

Mosquito traps or lures are well known implements for monitoring mosquito populations. Such devices are often used for disease surveillance because some mosquito species are capable of transmitting pathogenic agents to humans and other animals. The disease agent is transmitted when an infected female mosquito bites its host to extract blood as a source of protein to mature her eggs.

However, when carbon dioxide, either alone or in combination with an attractant such as octenol or another aromatic substance is used to create a plume to attract the mosquitoes, for efficiency of mosquito trapping sake, it is necessary to weigh the amount of octenol remaining to determine how much of the emitted octenol emitted in the plume attracts a particular quantity of mosquitoes. In this process, distortions regarding the amount of emitted octenol are experienced due to the fact that octenol is a humectant that absorbs a significant amount of moisture. Therefore, in a very humid environment, a weighing of remaining or unused octenol may be almost equal to the initial amount utilized as an attractant, due to the absorption of moisture.

Accordingly, by the use of a confined release chamber with a desiccant in its inlet that allows a metered amount of carbon dioxide to admix with octenol and exit the chamber as a plume, we have significantly eliminated or minimized the amount of moisture capable of being absorbed into the octenol.

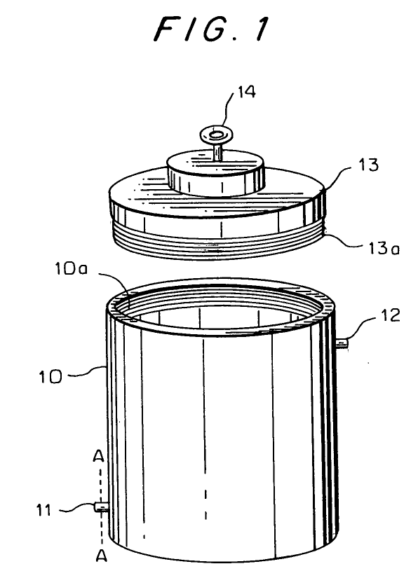

Reference is now made to FIG. 1 which shows the exterior of the confined release chamber 10 having an inlet 11 for infusion of carbon dioxide gas and an outlet 12 to emit plumes of carbon dioxide gas in admixture with an aromatic mosquito lure such as octenol, wherein the admixture is a lure or attractant for mosquitoes. The chamber is fitted with a cap 13 with threadings 13a or turnings that allow it to be threaded into the interior threadings or turnings 10a at the top of the chamber 10 to affect tight closure. The cap is fitted with an eye screw 14 that enables the chamber to be suspended above the ground, as this is the most expeditious way to affect luring of mosquitoes from all directions.

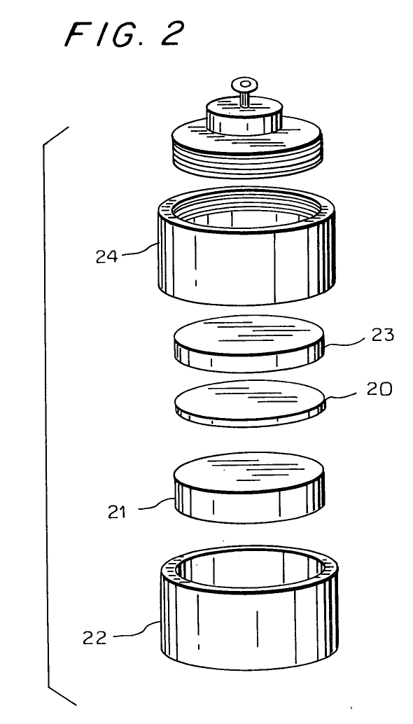

In the exploded view of the confined release chamber shown in FIG. 2, there is shown a side view of a vial slip plate 20 that seats into a connector 21, which in turn seats into a drain end cap 22 for positioning inside of the bottom part of the release chamber. A connector 23 of a circumference slightly greater than that of vial slip plate 20 interconnects at element 22 with a drain clean-out circumferencial member 24 to complete the interior components of the confined release chamber. When in use the chamber is sealed with a thin coating of petroleum jelly or any other removable sealant placed on the threadings.

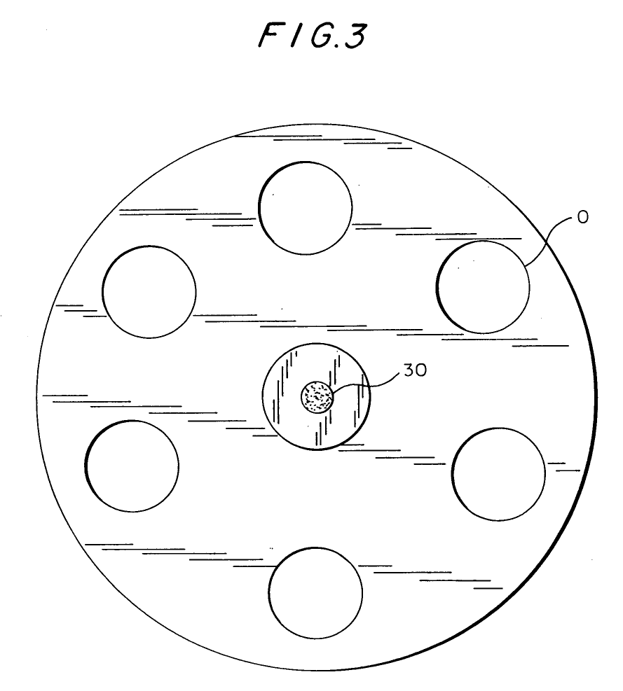

FIG. 3 is a top view of the vial slip plate 20 showing circular openings 0 in which vials containing octenol or any other aromatic attractant substance are placed.

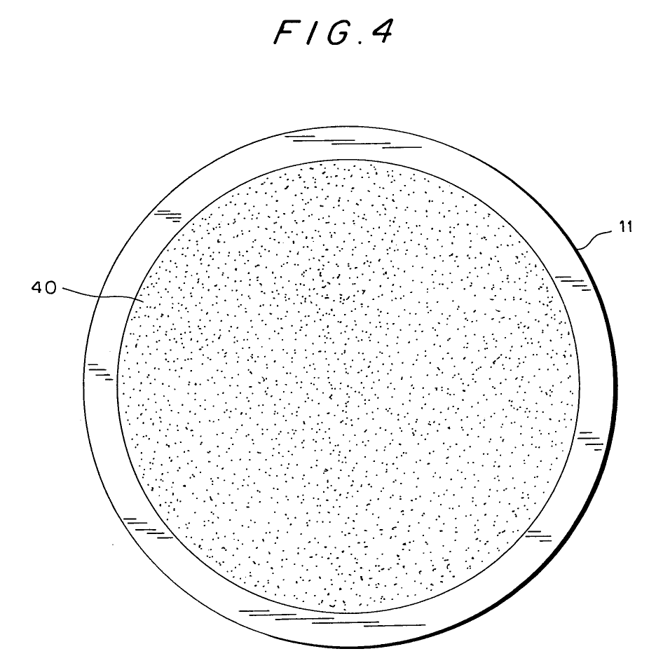

FIG. 4 is an enlarged view of inlet 11 taken along line A-A, showing the use of a desiccant 40 disposed in the inlet. The desiccant may be anhydrous calcium sulfate or any other desiccant that is a hygroscopic substance that induces or sustains a state of dryness in its local vicinity in a moderately-well sealed container. The desiccant may be pre-packaged and is preferably a solid that works through absorption or adsorption of water, or a combination of the two. Further, the desiccant may be in a form other than solid and may work through other principles, such as chemical bonding of water molecules. Any desiccant will work as long as it removes humidity that would be absorbed into the attractant to offset or distort the weight of unused attractant left after a mixture of attractant and carbon dioxide has been emitted throughout the outlet to attract mosquitoes.

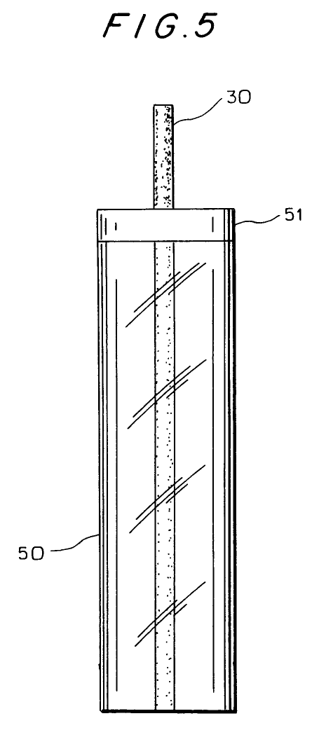

FIG. 5 depicts a side view of a vial containing the attractant 50. The vial is fitted with a cap 51 with an aperture in its top through which a wick 30 extends. The wick wetted with the attractant allows attractant vapors to mix with the CO₂ so that an admixture of CO₂ and attractant effuses from the outlet of the chamber.

The apparatus of the invention will essentially include the following:
a) means for regulating the flow of CO₂ through an inlet containing a desiccant of a confined chamber;
b) means for allowing CO₂ to admix with a vaporized attractant liquid enclosed means within said confined chamber;
c) outlet means from said confined chamber to permit a plume of desiccated CO₂ and attractant to be emitted as a plume into an atmosphere containing mosquitoes; and
d) means for allowing liquid attractant left in said enclosed chamber to be weighed to ascertain the number of mosquitoes attracted per amount of emitted attractant.

In practicing the method of maximizing attraction of mosquitoes of the invention, screened outdoor cages having a dimension of 56.7 m (l)×9.4 m (w)×2.6 m (h) (screen mesh size 18×14) are employed. The confined release chamber is suspended by the eye screw 14 as shown in picture Exhibit A. In Exhibit A, a pressurized tank of CO₂ is placed on the ground and regulates the flow of CO₂ at about 500 ml min through the inlet 11 of the confined release chamber, where the force of the CO₂ induces admixture with octenol vapors escaping from the wick of the vial to create an admixture that exits through outlet 12, as a plume of carbon dioxide and octenol.

Picture Exhibit B shows a close-up of the suspended confined release chamber with connections to the inlet and outlet and picture Exhibit frame C shows a top view of the confined release chamber minus cap 13.

Test to determine the efficacy of the apparatus is as follows:
At noon, approx. 12,000 adult mosquitoes each of Aedes albopictus and Culex quinquefasciatus were released into each ⅓ of cage.

Four hours later, traps were turned on (1600 h) and collections were picked up at 0800 h the next day (16 hr).

The weights were taken prior to field deployment and put out at time of turning traps on, then brought into lab weighed again at time of collection pickup (mg/h), and tables were prepared using the statistics method of multiple comparisons of the Student-Neuman-Keuls procedure developed in 1952.

Mean Release Rate >>5 mg/h

The results of this test are shown in the following Tables.

TABLE I
Mean female Aedes albopictus suction trap collections baited
with 1-octen-3-ol with and without CO₂.

| | No CO₂ | With CO₂ |
|---|---|---|
| 1-octen-3-ol | 165.3a | 684.5a |
| CO₂ only | 614.8b | 903.3a |

Column with the same letter are not significant (P > 0.05).

TABLE II
Mean female Aedes albopictus suction trap collections baited
1-octen-3-ol with and without CO₂.

| | No CO₂ | With CO₂ |
|---|---|---|
| 1-octen-3-ol | 230.5a | 644.2a |
| CO₂ only | 1162.8b | 690.2a |

Column with the same letter are not significant (P > 0.05).

TABLE III
Mean female Aedes albopictus suction trap collections baited
with 1-octen-3-ol with and without CO₂.

| | No CO₂ | With CO₂ |
|---|---|---|
| 1-octen-3-ol | 101.3a | 845.3a |
| CO₂ only | 647.8b | 746.5a |

Column with the same letter are not significant (P > 0.05).

TABLE IV
Mean female Culex quinquefasciatus suction trap collections
baited 1-octen-3-ol with and without CO₂.

| | No CO₂ | With CO₂ |
|---|---|---|
| 1-octen-3-ol | 32.0a | 538.5a |
| CO₂ only | 2361.8b | 1422.3a |

Column with the same letter are not significant (P > 0.05).

TABLE V
Mean female Culex quinquefasciatus suction trap collections
baited with 1-octen-3-ol with and without CO₂.

| | No CO₂ | With CO₂ |
|---|---|---|
| 1-octen-3-ol | 47.7a | 980.3a |
| CO₂ only | 3754.8b | 1690.0a |

Column with the same letter are not significant (P > 0.05).

We claim:

1. In a method of attracting mosquitoes using a mixture of carbon dioxide and a mosquito attractant, the improvement of maximizing attraction by preventing or substantially minimizing absorption of moisture into the attractant that would distort the weight of the attractant left after effusion of attractant in a plume, comprising:
a) regulating flow of CO₂ through an inlet containing a desiccant into a confined chamber;
b) allowing CO₂ from step a) to admix with an attractant vapor emitted from a wick extending through an opening in an enclosed vial containing a liquid attractant in said confined chamber;
c) emitting an admixture of desiccated CO₂ and attractant as a plume through an outlet of the confined chamber to lure mosquitoes for a predetermined time; and
d) weighing the amount of liquid attractant left in said enclosed vial to ascertain the amount of vaporous attractant emitted in the plume to ascertain the number of mosquitoes attracted per amount of attractant.

2. The method of claim 1 wherein the flow of the CO₂ is regulated at a rate of about 500 ml/min.

3. The method of claim 2 where said attractant is an analog of 1-octen-3-ol.

4. The method of claim 3 wherein the analog of 1-octen-3-ol is selected from the group consisting of 10 alkenols synthesized as cis(Z)/trans(E)-2-alkene-4-ol.

5. The method of claim 4 wherein said 10 alkenols synthesized as cis(Z)/trans(E)-2-alkene-4-ol is selected from 6-7 carbon alkenols.

6. The method of claim 4 wherein said 10 alkenols synthesized as cis(Z)/trans(E)-2-alkene-4-ol is selected from 8-9 carbon alkenols.

7. The method of claim 2 wherein said mosquito attractant is octenol.

8. The method of claim 7 wherein said desiccant is a solid.

9. The method of claim 8 wherein said solid desiccant is anhydrous calcium sulfate.

10. The method of claim 9 wherein said anhydrous calcium sulfate is 10 to 20 mesh.

11. A mosquito attracting apparatus for maximizing attraction of mosquitoes by preventing or substantially minimizing absorption of moisture into the attractant that would distort the weight of the attractant left after effusion of attractant in an emitted plume, comprising:
a) means for regulating the flow of CO₂ through an inlet containing a desiccant of a confined chamber;
b) means for allowing CO₂ to admix with a vaporized attractant liquid enclosed means within said confined chamber;
c) outlet means from said confined chamber to permit a plume of desiccated CO₂ and attractant to be emitted as a plume into an atmosphere containing mosquitoes; and
d) means for allowing liquid attractant left in said enclosed chamber to be weighed to ascertain the number of mosquitoes attracted per amount of emitted attractant.

12. The apparatus of claim 11 wherein said means for allowing CO₂ to admix with said vaporized attractant liquid is a capped vial with an aperture through which a wick extends to emit vapors of said attractant liquid.

13. In combination, the apparatus of claim 12 containing calcium sulfate as the desiccant and a mixture of CO₂ and analog of 1-octen-3-ol as the attractant.

14. In combination, the apparatus of claim 13 containing calcium sulfate as the desiccant and a mixture of CO₂ and analog of 10 alkenols synthesized as cis(Z)/trans(E)-2-alkene-4-ol as the attractant.

15. In combination, the apparatus of claim 13 containing an analog of 10 alkenols synthesized as cis(Z)/trans(E)-2-alkene-4-ol selected from 6-7 carbon alkenols as the attractant.

16. In combination, the apparatus of claim 13 containing an analog of 10 alkenols synthesized as cis(Z)/trans(E)-2-alkene-4-ol selected from 8-9 carbon alkenols as the attractant.

17. In combination, the apparatus of claim 13 containing octenol as the attractant.

18. In combination, the apparatus of claim 17 wherein said anhydrous calcium sulfate is 10 to 20 mesh.
